(19) United States
(12) Patent Application Publication
(10) Pub. No.: US 2026/0085226 A1
(43) Pub. Date: Mar. 26, 2026

(54) Microcapsules for Controlled Flow Diverter Formation in Geothermal Reservoirs and Method of Use Thereof

(71) Applicant: The Regents of the University of California, Oakland, CA (US)

(72) Inventors: Chun Chang, Emeryville, CA (US); Seiji Nakagawa, El Cerrito, CA (US); Timothy J. Kneafsey, Albany, CA (US); Patrick Dobson, Livermore, CA (US)

(21) Appl. No.: 19/331,024

(22) Filed: Sep. 17, 2025

Related U.S. Application Data
(60) Provisional application No. 63/698,157, filed on Sep. 24, 2024.

(51) Int. Cl. C09K 8/467; C04B 22/06; C04B 28/26; C04B 40/06; C09K 8/42; E21B 33/138

(52) U.S. Cl. CPC C09K 8/467; C04B 22/062; C04B 28/26; C04B 40/0641; C09K 8/426; E21B 33/138

(57) ABSTRACT

This disclosure provides systems, methods, and apparatus related to microcapsules for controlled flow diverter formation in geothermal reservoirs and method of use thereof. In one aspect, a method include providing microcapsules comprising a shell encapsulating an acid. The microcapsules are mixed with a metal silicate to form a mixture. The mixture is injected the mixture into a geothermal reservoir. The shell degrades at an elevated temperature within the geothermal reservoir such that the acid reacts with the metal silicate to generate a precipitate or a gel.

### RELATED APPLICATIONS

This application claims priority to U.S. Provisional Patent Application No. 63/698,157, filed 24 Sep. 2024, which is hereby incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

Enhanced Geothermal Systems (EGS) involve subsurface reservoirs where there is hot rock (175 to 300+° C.) but little to no natural permeability and/or a sufficient volume of producible fluid. As identified by the U.S. Department of Energy's (DOE's) Geothermal Technologies Office's (GTO) 2019 GeoVision report, the development of EGS-enabling technologies could increase geothermal power generation nearly 26-fold from today, representing 60 gigawatts-electric (GWe) of ‘always-on’, flexible electricity-generation capacity by 2050. This would comprise 3.7% of the total U.S. installed capacity and 8.5% of all U.S. electricity generation in 2050.

During EGS development, subsurface permeability is enhanced via stimulation processes that re-open pre-existing fractures, create new ones, or achieve a combination of both. These newly created, highly conductive conduits allow fluid to circulate throughout the stimulated rock volume. However, even when a well-distributed flow network is created successfully, because of the heterogeneity of the fracture properties such as geometry, aperture, connectivity, and their time-dependent evolution, some fractures will take more flow than others. This potentially leads to heat extraction from only a small portion of the reservoir, resulting in rapid thermal decline of the heat extraction fluid. Thus, the ability to control the fluid flow within a created reservoir and optimize the subsurface heat exchange performance in stimulated fractures is important for developing sustainable and economical EGS. Current approaches for altering reservoir fluid flow target the near-wellbore environment include a variety of well completion and zonal isolation methods by which fluid flow into or out of a well is controlled.

Although management of near-wellbore fluid flow is important for maintaining fluid production from EGS reservoirs, it has limited impact in controlling the fluid flow away from the wells for optimization of heat recovery and reservoir performance.

### SUMMARY

As described herein, the delivery one or more components of diverter-forming chemicals in microparticles (capsules) with a thin shell (e.g., polymer shell) can be used to control the timing of the flow-diverter formation. The material properties of the shell are designed so that it can withstand moderately high temperatures (e.g., up to about 200° C.) of the injected fluid for a short period of time (e.g., up to about 30 minutes), but thermally degrade and release the reactants at higher reservoir temperatures. A microfluidic system was developed that can produce reactant-encapsulating particles. The diameter of the produced particles was about 250 μm to 650 μm, which can be controlled by using capillary tubes with different diameters and by adjusting the flow rates of the encapsulated fluid and the UV-curable epoxy resin for the shell.

Preliminary experiments demonstrated that: (1) microcapsules containing chemical activators for flow-diverter (e.g., silicate gel or metal silicate) formation can be produced; (2) the durability of the shell can be made to satisfy the required conditions; and (3) thermal degradation of the shell allows for release of the reaction activators and control of reaction kinetics in silica-based diverters.

One innovative aspect of the subject matter described in this disclosure can be implemented in an method including providing microcapsules comprising a shell encapsulating an acid. The microcapsules are mixed with a metal silicate to form a mixture. The mixture is injected into a geothermal reservoir. The shell degrades at an elevated temperature within the geothermal reservoir such that the acid reacts with the metal silicate to generate a precipitate or a gel.

Another innovative aspect of the subject matter described in this disclosure can be implemented in a method including providing microcapsules comprising a shell encapsulating an acid. The microcapsules are mixed with a sodium silicate to form a mixture. The mixture is injected into a geothermal reservoir. The shell degrades at an elevated temperature within the geothermal reservoir such that the acid reacts with the sodium silicate to form silicon oxide.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a schematic illustration a microfluidic device for producing microcapsules.

FIG. 2 shows an example of cross-sectional schematic illustration of a microcapsule.

FIG. 3 shows an example of a flow diagram illustrating a process for using microcapsules to block a feature in a geothermal reservoir.

FIGS. 4A-4D show photographs of the hydrothermal tests using acetic acid (50 wt. %) encapsulated microcapsules with 40 wt. % sodium silicate at 150° C. FIGS. 4E and 4F show microscope images of the silica gel plug after shell breach.

FIG. 5A-5D show photographs of the hydrothermal tests on acetic acid (50 wt. %) encapsulated microcapsules with 10 wt. % sodium silicate at 150° C. FIGS. 5E and 5F show microscope images of the silica gel plug after shell breach.

FIGS. 6A and 6B show schematic diagrams of the different silica gel structures created by microcapsules with 40 wt. % vs. 10 wt. % sodium silicate. Once the epoxy shell is degraded and breached at elevated temperature, the reaction can be accelerated by the natural mixing of reactants, increased interfacial area, and reduced diffusion length. Higher reactant concentration led to more extensive gelation and solid plug formation.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

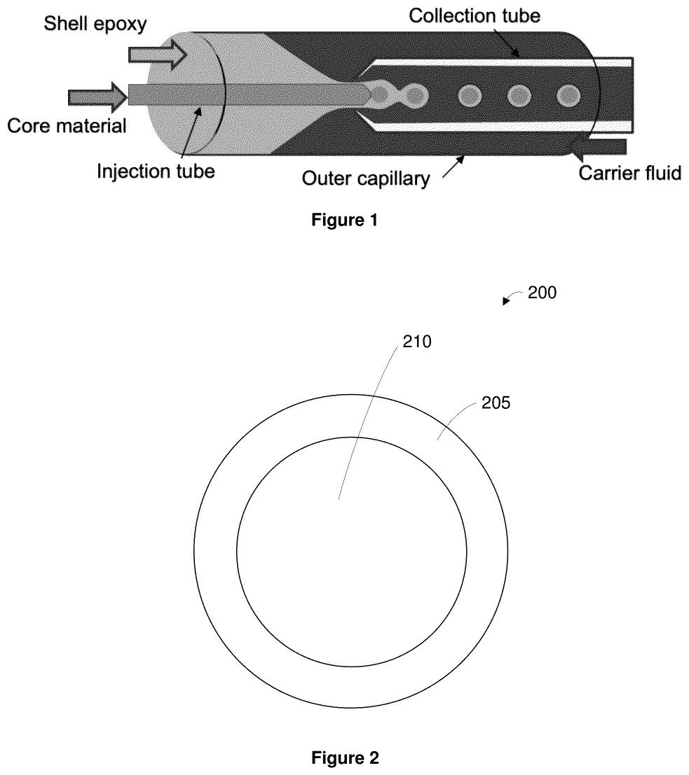

The single-step microfluidic encapsulation method, which involves a three-phase glass capillary device, is a technique for generating microcapsules with well-controlled geometry. The technique involves a combined co-flow and counter-current flow in a glass capillary device. The microcapsules are then produced through a flow focusing mechanism in which fluids containing core and shell materials are forced through a narrow junction. In addition to the core and shell fluid, the system consists of an outer carrier fluid. The capillary junction simultaneously pinches off the interior core and exterior shell fluids, forming a double-layer droplet suspended in the outer carrier fluid (FIG. 1). The carrier fluid is used to stabilize the droplets. Once the double-layer droplets are formed, the outer shell, comprising a photopolymer material, is photopolymerized by UV light to form the microcapsule. See Arriaga, L. R., Amstad, E., and Weitz, D. A. “Scalable single-step microfluidic production of single-core double emulsions with ultra-thin shells.” Lab Chip, 15, (2015), 3335 and Nabavi, S. A., Vladisavljević, G. T., Gu, S., Ekanem, E. E. “Double emulsion production in glass capillary microfluidic device: parametric investigation of droplet generation behavior.” Chem. Eng. Sci., 130, (2015), 183-196 for further details regarding microcapsule generation. Both of the preceding references are hereby incorporated by reference.

Compared to the classic two-step microfluidic encapsulation approach, advantages of the single-step microfluidic encapsulation include: (1) the easy control of individual flow rates, because the flow rates of the inner and middle fluid do not need to be synchronized; (2) the capability of generating thin shelled particles; and (3) the simpler system design and smaller number of capillaries and connectors, which makes it easier to fabricate than the device composed of two sequential drop generation units.

FIG. 2 shows an example of cross-sectional schematic illustration of a microcapsule. A microcapsule 200 comprises a shell 205 and an acid 210 encapsulated by the shell 205. In some embodiments, the shell 205 is an organic material. In some embodiments, the shell 205 comprises a polymer. In some embodiments, the shell 205 comprises an epoxy. In some embodiments, the shell 205 is an inorganic material. In some embodiments, the shell 205 comprises silica.

In some embodiments, the acid is hydrochloric acid or acetic acid. In some embodiments, the acid 210 is an acid from a group hydrochloric acid, sulfuric acid, nitric acid, acetic acid, citric acid, and formic acid. In some embodiments, the acid has a pH of about 0 to 4. In some embodiments, the acid 210 is about 5 wt % to 50 wt % of a solution encapsulated by the shell of a microcapsule.

In some embodiments, the microcapsule 200 has a dimension of about 250 microns to 650 microns. In some embodiments, the microcapsule 200 is substantially spherical. In some embodiments, the microcapsule 200 has a diameter of about 250 microns to 650 microns. In some embodiments, the shell 205 is about 30 microns to 110 microns thick.

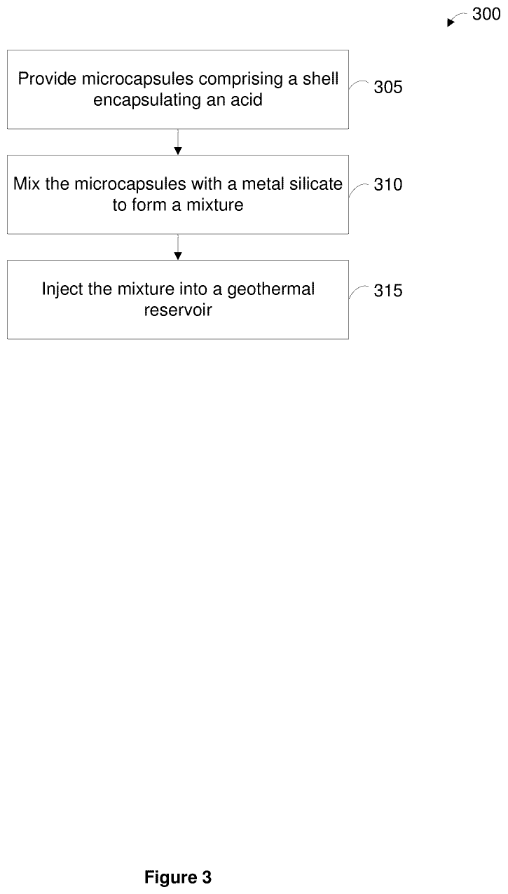

FIG. 3 shows an example of a flow diagram illustrating a process for using microcapsules to a block feature in a geothermal reservoir. Starting at block 305 of the process 300 shown in FIG. 3, microcapsules are provided. The microcapsules comprise a shell encapsulating an acid.

In some embodiments, the shell is an organic material. In some embodiments, the shell comprises a polymer. In some embodiments, the shell comprises an epoxy (e.g., an UV-curable epoxy). In some embodiments, the shell is an inorganic material. In some embodiments, the shell comprises silica.

In some embodiments, the acid is hydrochloric acid or acetic acid. In some embodiments, the acid is an acid from a group hydrochloric acid, sulfuric acid, nitric acid, acetic acid, citric acid, and formic acid. In some embodiments, the acid has a pH of about 0 to 4, or about 0 to 3. In some embodiments, the acid 210 is about 5 wt % to 50 wt % of a solution encapsulated by a shell of a microcapsule.

In some embodiments, acetic acid may be used as acetic acid can deliver the same amount of H⁺ compared to strong acid (e.g., such as HCl) without having low pH. In some embodiments, a higher-concentration acid may be used in the microcapsules because the acid will be diluted once released.

In some embodiments, the microcapsules have a dimension of about 250 microns to 650 microns. In some embodiments, the microcapsules are substantially spherical. In some embodiments, the microcapsules have a diameter of about 250 microns to 650 microns. In some embodiments, the shell is about 30 microns to 330 microns thick.

At block 310, the microcapsules are mixed with a metal silicate to form a mixture. In some embodiments, the metal silicate is dissolved in a carrier fluid. In some embodiments, the metal silicate is dissolved in water. In some embodiments, the metal silicate is dissolved in water, and the water is about 60 wt % to 95 wt %, or about 90 wt %, of the metal silicate/water solution. In some embodiments, the mixture comprises about 2.5 to 25 weight % acid and 2.5 to 20 weight % metal silicate.

At block 315, the mixture is injected into a geothermal reservoir. The shell degrades at an elevated temperature within the geothermal reservoir such that the acid reacts with the metal silicate to generate a precipitate or a gel. In some embodiments, the shell degrades at about 150° C. to 300° C., or at about 150° C. to 200° C., in about 30 minutes to 60 minutes. In some embodiments, the precipitate or the gel serves to block a portion of pathways or fractures (e.g., high permeability fractures) within the geothermal reservoir. In some embodiments, the metal silicate comprises sodium silicate, and the precipitate or the gel comprises silicon oxide.

In some embodiments, the process 300 further comprises injecting a solution having pH of about 10 to 14, or pH of about 12 to 14, into the geothermal reservoir proximate the precipitate or the gel. The solution serves to dissolve the precipitate or the gel. In some embodiments, the solution comprises sodium hydroxide or potassium hydroxide.

Described below in the EXAMPLES is a study of reducing and managing the permeability of fast flow paths within an EGS reservoir far away from both injection and production wells to divert and distribute the flow to a larger reservoir volume. Three components of the described technology include: (1) microparticles (capsules) containing the reactants (“encapsulated microparticles”), for delaying the diverter-forming reactions until the particles are transported to a desired reservoir location, by optimizing the capsule's shell properties; (2) silica-gel and metal-silicate-based flow diverters that are stable under EGS conditions and can be dissolved and disintegrated when needed; and (3) controlled reaction of the diverter-forming components to produce effective diverter plugs away from the well, which is made possible by the understanding of the degradation (or triggering) and transport characteristics of the reactant-delivering microcapsules.

The following examples are intended to be examples of the embodiments disclosed herein, and are not intended to be limiting.

### Example—Microfluidic-Based Encapsulation System and Microcapsules

A system to produce reactant-encapsulating microcapsules was developed. The system comprised three syringe pumps and capillary tubes to deliver core, shell materials, and the carrier fluid. A 100-watt UV lamp was used for curing the epoxy shell in tube.

After a systematic evaluation of the polymer shell materials that could be potentially used for geothermal applications, NOA 61 UV-curable epoxy (Norland Products, NJ) was selected for its low viscosity, fast UV curing time, and high temperature stability. The two materials which were used were water stained with a fluorescent tracer dye and acetic acid (10 wt. % to 50 wt. %) stained with blue food dye. The carrier fluids were either silicone oil or mineral oil with a lower viscosity. During production, the particle size and shell thickness were changed by controlling the relative magnitudes of viscous, capillary and inertial forces of the three fluids used in the microfluidic device.

The system was capable of producing microcapsules with a particle diameter of about 250 μm to 650 μm and a core diameter of about 220 μm to 540 μm. After being UV cured and dried, the microcapsules were tested under elevated temperature and pressure relevant to EGS conditions.

### Example—Silicate-Gel-Based Flow Diverter

The precursor used for diverter formation in this study was sodium silicate, which starts the gelation reaction in the presence of acid activators. The acid activators could be either strong acids (e.g., HCl, H₂SO₄, HNO₃) or weak acids (e.g., acetic acid, citric acid, formic acid). When acid activators are delivered via microcapsules, the total amount of the acid that can be delivered to the target location would be limited by the volume and concentration of the particles in the injected fluid. This makes it useful to use a highly concentrated acid. Weak, organic acids keep the pH at a safe, acceptable level, while providing the necessary amount of H⁺. When organic weak acids are used, however, their temperature stability under the EGS conditions needs to be considered.

For this research, acetic acid was selected since it has been shown to be stable up to about 230° C. for 72 hours. The reaction between sodium silicate and acetic acid can be summarized as follows:

$${( {Na}_{2} O )}_{x} {( {SiO}_{2} )}_{y ( liquid )} + 2 \times CH 3 {COOH}_{( liquid )} \to {( SiO )}_{y ( solid )} + 2 \times CH 3 {COOH}_{( liquid )} + {x H}_{2} O \qquad EQ . ( 1 )$$

### Example—Hydrothermal Experiments

Hydrothermal experiments were conducted on the produced microcapsules and sodium silicate solutions to investigate the thermal degradation behavior of microcapsules and control of silica gel plug formation. The primary equipment used in this research was a series of small, stainless-steel Parr reactor vessels. Small, sealable internal cells made of corrosion-resistant grade-2 titanium with high-temperature Viton O-rings (rated for 230° C.) were also used. It was demonstrated that the system could contain water vapor at 200° C. without any pressure loss over 1 month, which is important for maintaining constant reaction environment and simulating EGS conditions.

### Example—Thermal Degradation of Microcapsules and Control of Silicate Gel Plug Formation

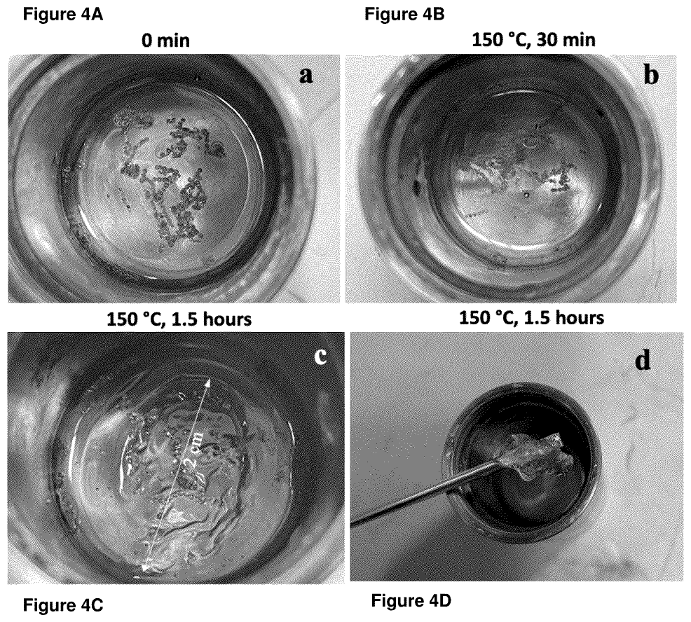

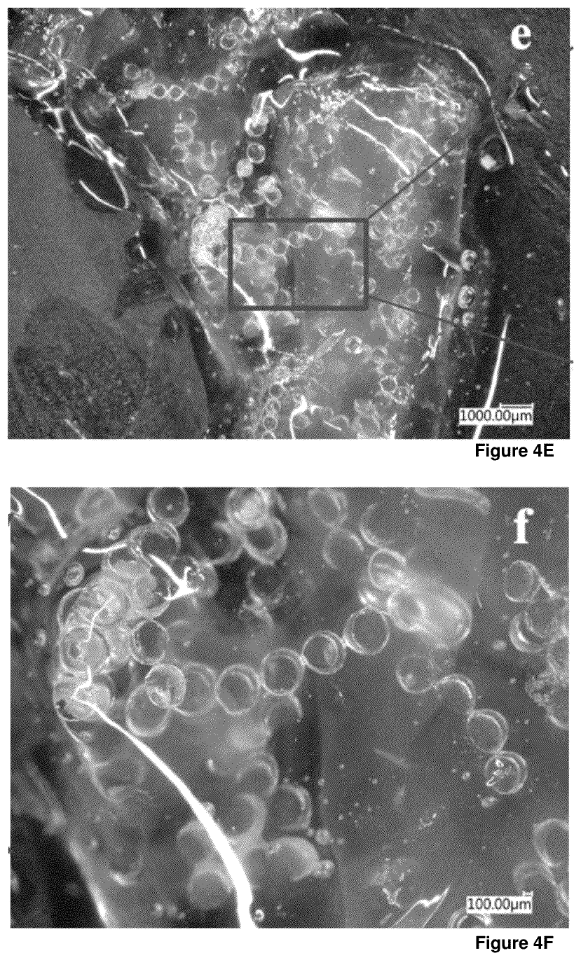

The microcapsules were fabricated and hydrothermal tests were conducted at temperatures of 150° C. to 200° C., with 10 g each of 10 wt. % and 40 wt. % sodium silicate solutions. FIGS. 4A-4F show images from the tests, with the microcapsules and 40 wt. % sodium silicate solution at 150° C. for up to 1.5 hours. As shown in FIGS. 4A-4D, the epoxy shell successfully isolated and protected the core reactant (50 wt. % acetic acid) from sodium silicate solution for at least 30 minutes at 150° C. After exposure for 1.5 hours, the degradation and breach of the epoxy shell released acetic acid and initiated reaction with the surrounding sodium silicate solution, forming an intact gel plug with a length up to 2.0 cm. Microscope images of the gel plug showed the degradation of microcapsules, leaving a semi-spherical shell structure within the plug (FIGS. 4E and 4F).

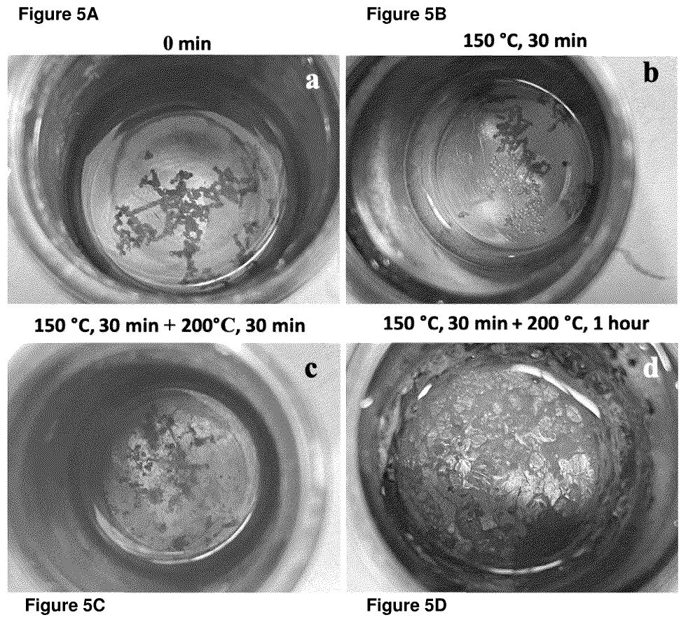

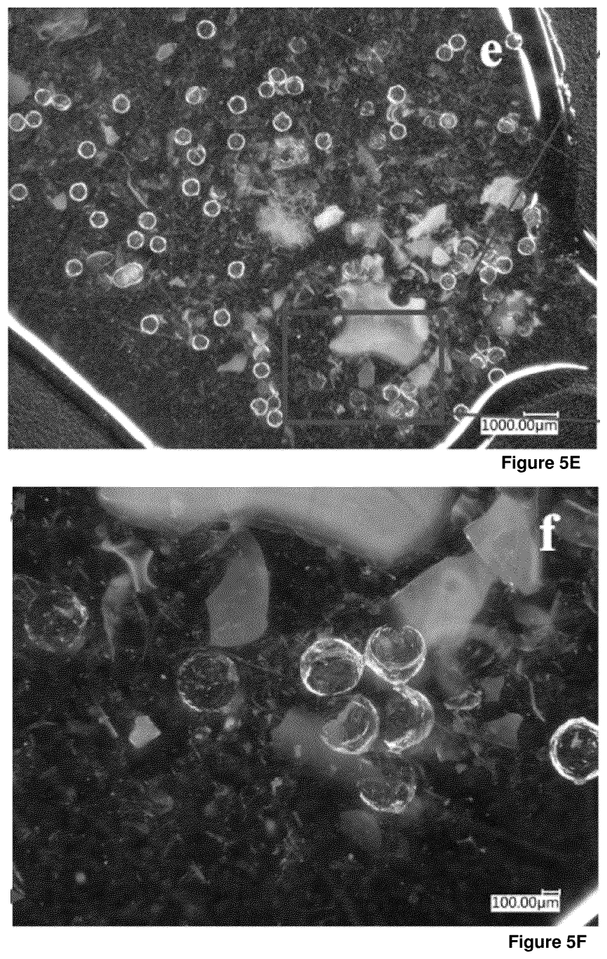

Hydrothermal experiments on the produced microcapsules with 10 wt. % sodium silicate at temperatures of 150° C. to 200° C. were also conducted (FIGS. 5A-5F). Similar to FIG. 4B, FIG. 5B shows the stability of produced microcapsules after 30 minute of exposure at 150° C. The system was heated at 200° C. for another 30 minutes. FIG. 5C shows partial degradation of the microcapsules and scattered, local formation of silica gel. Extensive silica gel formation occurred (FIG. 5D) after 30 minutes of exposure at 150° C. and 1 hour of exposure at 200° C. The microscope images in FIGS. 5E and 5F after plug formation indicate breach and degradation of the microcapsules.

Note that the character of the silicate gel plugs are very different in the two hydrothermal tests using 40 wt. % vs. 10 wt. % sodium silicate solutions. 40 wt. % sodium silicate produced a single, centimeter-scale solid plug. In contrast, 10 wt. % resulted in interconnected smaller plugs, exhibiting a porous and mesh-like overall structure.

Although using reactant-encapsulating microcapsules will allow delayed reaction and formation of diverter plugs, it was anticipated that the presence of the shells might severely restrict mixing of the reactants, resulting in undesirable plug geometry and even incomplete reaction by barrier formation. Fortunately, the results shown in FIGS. 4A-4F and FIG. 5A-5F indicate this may not be the case. This may be primarily due to the small size of the microcapsules, which reduces the necessary diffusion length for mixing, and to efficient degradation of the shell.

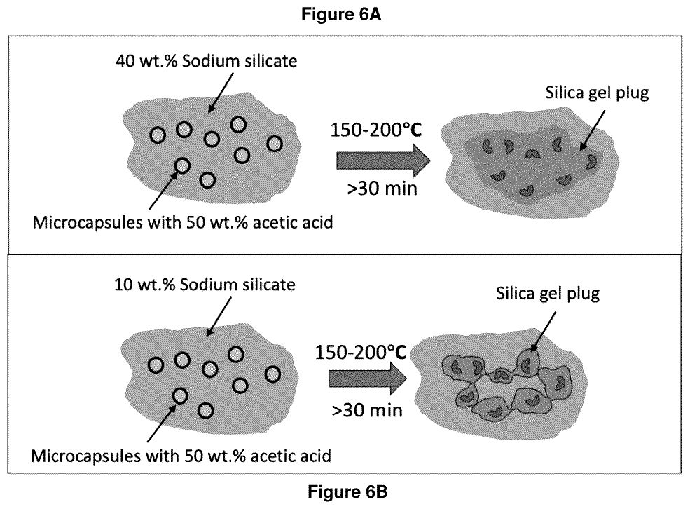

It was also observed that relatively high concentrations of the sodium silicate solution and the particle volume are necessary to achieve high-quality diverter plugs (FIGS. 6A and 6B). For practical application, optimization of the particle size and concentration would be necessary for controlled, high-quality plug formation in desired reservoir locations after microcapsule delivery.

These results show that (1) the microcapsules delayed reactions by 0.5 hour to 1 hours and that (2) once triggered, the reaction can be enhanced by the increased reactive interfacial areas and reduced diffusion length.

### CONCLUSION

Further details regarding the embodiments described herein can be found in Chun Chang et al., “Development of Chemical-Encapsulating Microparticles for Delayed Flow Diverter Formation in EGS Reservoirs Away from Wells”, GRC Transactions, Vol. 47, 2023, which is hereby incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
providing microcapsules comprising a shell encapsulating an acid;
mixing the microcapsules with a metal silicate to form a mixture; and
injecting the mixture into a geothermal reservoir, the shell degrading at an elevated temperature within the geothermal reservoir such that the acid reacts with the metal silicate to generate a precipitate or a gel.

2. The method of claim 1, wherein the precipitate or the gel is a metal oxide.

3. The method of claim 1, wherein the precipitate or the gel is silicon oxide.

4. The method of claim 1, wherein the shell is an organic material.

5. The method of claim 1, wherein the shell is an inorganic material.

6. The method of claim 1, wherein the acid is an acid from a group hydrochloric acid, sulfuric acid, nitric acid, acetic acid, citric acid, and formic acid.

7. The method of claim 1, wherein the acid has a pH of about 0 to 4.

8. The method of claim 1, wherein the acid is about 5 wt % to 50 wt % of a solution encapsulated by the shells of the microcapsules.

9. The method of claim 1, wherein the microcapsules have a dimension of about 250 microns to 650 microns.

10. The method of claim 1, wherein the microcapsules are substantially spherical.

11. The method of claim 1, wherein the shell is about 30 microns to 110 microns thick.

12. The method of claim 1, wherein the metal silicate is dissolved in a carrier fluid.

13. The method of claim 1, wherein the metal silicate is dissolved in water, and wherein the water is about 60 wt % to 95 wt %.

14. The method of claim 1, the mixture comprises about 2.5 to 25 weight % acid and 2.5 to 20 weight % metal silicate.

15. The method of claim 1, wherein the shell degrades at about 150° C. to 300° C. in about 30 minutes to 60 minutes.

16. The method of claim 1, wherein the metal silicate comprises sodium silicate, and wherein the precipitate or the gel comprises sodium oxide.

17. The method of claim 1, wherein the precipitate or the gel serves to block a portion of pathways within the geothermal reservoir.

18. The method of claim 1, further comprising:
injecting a solution having pH of about 10 to 14 into the geothermal reservoir proximate the precipitate or the gel, the solution serving to dissolve the precipitate or the gel.

19. The method of claim 1, wherein the solution comprises sodium hydroxide or potassium hydroxide.

20. A method comprising:
providing microcapsules comprising a shell encapsulating an acid;
mixing the microcapsules with a sodium silicate to form a mixture; and
injecting the mixture into a geothermal reservoir, the shell degrading at an elevated temperature within the geothermal reservoir such that the acid reacts with the sodium silicate to form silicon oxide.
